(19) United States
(12) Patent Application Publication
(10) Pub. No.: US 2007/0096364 A1
(43) Pub. Date: May 3, 2007

(54) Sandwich molding system with independent runner passages

(75) Inventors: John J. Hahn, Hartford, WI (US); Brian Hartlmeier, Elm Grove, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: MGS Mfg. Group, Inc.

(21) Appl. No.: 11/265,913

(22) Filed: Nov. 3, 2005

(51) Int. Cl. B29C 45/16

(52) U.S. Cl. 264/255; 264/328.8; 425/573; 425/145; 425/542

(57) ABSTRACT

A method of sandwich molding employs independent runners for each of the first and second thermoplastic materials simplifying the construction of the mold and runner passages, facilitating use of hot runner systems and the like, and simplifying the balancing of flow in multiple cavity molds.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates generally to injection molding techniques and specifically to “sandwich” molding in which a second material is injected within a first material within a mold cavity.

In conventional injection molding, an injection nozzle injects a thermoplastic material into a mold cavity formed by two or more mold portions. The thermoplastic material passes from the injection nozzle along a runner passage in the mold through a gate (normally a constricted portion of the runner passage), and into the mold cavity.

When the thermoplastic material has cooled enough to solidify, the mold portions are separated, and the molded part and a “runner” formed in the runner passage are ejected. The ejection process may break the runner from the molded part or this may be done in a separate “degating” step.

In sandwich injection molding, two or more nozzles inject two materials, one after another through common gate, into the mold cavity. By proper control of the injection process, the second material is injected inside the first material so that the first material envelops the second material in a “sandwich.”

Sandwich molding is useful when the materials forming the center and outer surface of the molded part require different properties. For example, a recycled plastic material may be used in the center of the part while the outer surface may use a material having improved color, surface finish, and opacity.

A typical sandwich injection-molding machine may include multiple hoppers, a single plasticizing screw, and a mold. In this system, each of the hoppers contains un-melted thermoplastic pellets and feed a pre-determined amount of each type of thermoplastic pellet to the plasticizing screw on a process-controlled interval. The thermoplastic pellets melt, but do not mix with the other melted thermoplastic materials in the plasticizing screw. The nozzle attached to the plasticizing screw will inject a first shot of the desired “skin” material into the mold and then at a second shot of the desired “core” material into the mold cavity via the same runner passage. Because both shots enter the mold cavity at the same location, the core material is injected within the skin material.

Instead of using a single plasticizing screw for both thermoplastic materials, most sandwich injection molding machines include multiple plasticizing screws and injectors and a branched runner passage leading to a single gate. The branched runner passages include a valve or valves that open and close to control which branch supplies the flow of thermoplastic material to the common gate and the mold cavity. The valves that prevent backflow of the thermoplastic material from the active branch into the inactive branch are expensive to implement and prone to clogging.

Lemke U.S. Pat. No. 6,284,726, assigned to the same assignee as the present invention and hereby incorporated by reference, discloses a system for sandwich molding involving a branched runner passage which eliminates the need for valves. In Lemke, as the first nozzle injects the first thermoplastic material through the first branch, the second nozzle blocks the second branch to prevent the flow of the first thermoplastic material into the second runner. The second nozzle then injects the second thermoplastic material into the second branch as the first nozzle blocks the first branch to prevent backflow and mixing of materials.

### BRIEF SUMMARY OF THE INVENTION

The present inventor has discovered that sandwich molding can be performed using independent runner passages transporting only one type of thermoplastic material through separated gates. The present invention accordingly allows sandwich molding with simple runner passages that are more easily fabricated and adapted to hot runner systems and in which flow is more easily balanced in multiple cavity molds.

More specifically, the present invention provides a method of sandwich molding comprising the steps of joining a first mold portion and a second mold portion at a part line to define a mold cavity including a first runner passage and a second runner passage, the first runner passage having a first inlet leading to a first gate at a first location within the mold cavity, and the second runner passage having a second inlet leading to a second gate at a second location within the mold cavity. A first thermoplastic material is injected through the first runner passage into the mold cavity without filling the mold cavity; and while the first thermoplastic material is still molten, a second thermoplastic material is injected through the second runner passage to join the first thermoplastic material and fill the mold cavity.

It is thus an object of at least one embodiment of the invention to provide a method of fabricating molds for sandwich molding that does not require complex runner passage designs that can handle sequential flows of different materials.

The first and second gates can be positioned and the injection shots sized so that the first thermoplastic material is injected until it covers the second gate and/or so that the first thermoplastic material wholly envelops the second thermoplastic material.

Thus it is an object of at least one embodiment of the invention to provide a method of conventional sandwich molding where the different materials are injected at different points in the mold, simplifying mold design.

The point at which the first thermoplastic material covers the second gate may come when the mold is as little as 33 percent filled or less than 66 percent filled.

Thus it is an object of at least one embodiment of the invention to provide a sandwich molding technique in which a relatively thin skin of materials may cover a substantially thicker core material.

In at least one embodiment, the present invention may provide local heating elements such as hot runner passages, insulated hot runners, or a hot manifold to maintain the temperature of the thermoplastic material.

Thus, it is another object of at least one embodiment of the invention to provide simple runner passages that may be readily adapted to standard hot runner systems or the like.

In at least one embodiment, the present invention may provide at least one runner passage branch extending to a plurality of mold cavities.

Thus, it is another object of at least one embodiment of the invention to provide a simple runner topology that aids in balancing flow to each of the mold cavities in multi-cavity molds.

In at least one embodiment, the present invention may use a control system joining the mold portions and controlling the injection of the thermoplastic materials.

Thus, it is another object of at least one embodiment of this invention to provide a molding technique that may be easily implemented on standard controls used for injection molding.

These particular objects and advantages may apply to only some embodiments falling within the claims and thus do not define the scope of the invention.

### BRIEF DESCRIPTION OF THE DRAWINGS

FIG. 1 is a simplified perspective view of a sandwich injection molding system with independent runner passages according to a first embodiment showing independent runner passages that may inject thermoplastic material into the mold cavity at two separate locations;

FIG. 2 is a cross-sectional view taken along B-B of FIG. 1 showing injector nozzles positioned against runners comprising simple sprue bushings in preparation for injection into the mold cavity;

FIG. 3 is a figure similar to that of FIG. 2 showing the mold cavity after the first nozzle has injected the first thermoplastic material into the mold cavity from the gate of the first sprue bushing to a point covering the gate of the second sprue bushing;

FIG. 4 is a figure similar to that of FIG. 3 showing the mold after the second nozzle has injected the second thermoplastic material into the mold cavity to fill and become substantially wholly surrounded by the first thermoplastic material;

FIG. 5 is a figure similar to that of FIG. 4 showing a multi-cavity mold having branched independent runners according to a second embodiment of the invention;

FIG. 6 is a figure similar to that of FIG. 4 showing use of the invention to provide a molded part having the core material partially exposed for decorative or structural purposes;

FIG. 7 is a figure similar to that of FIG. 6 showing the use of the present invention to create a two material part in a single mold cavity;

FIG. 8 is a view similar to that of FIG. 6 of a mold for producing blow molding preforms showing use of the present invention for making preforms having different inner and outer layers;

FIG. 9 is a top perspective view of a mold allowing the production of separate molded inclusions within a part; and

FIG. 10 is a perspective view similar to that of FIG. 9 showing the use of the present invention with hook or tunnel gates opening off of the parting line.

### DETAILED DESCRIPTION OF THE PREFERRED EMBODIMENT

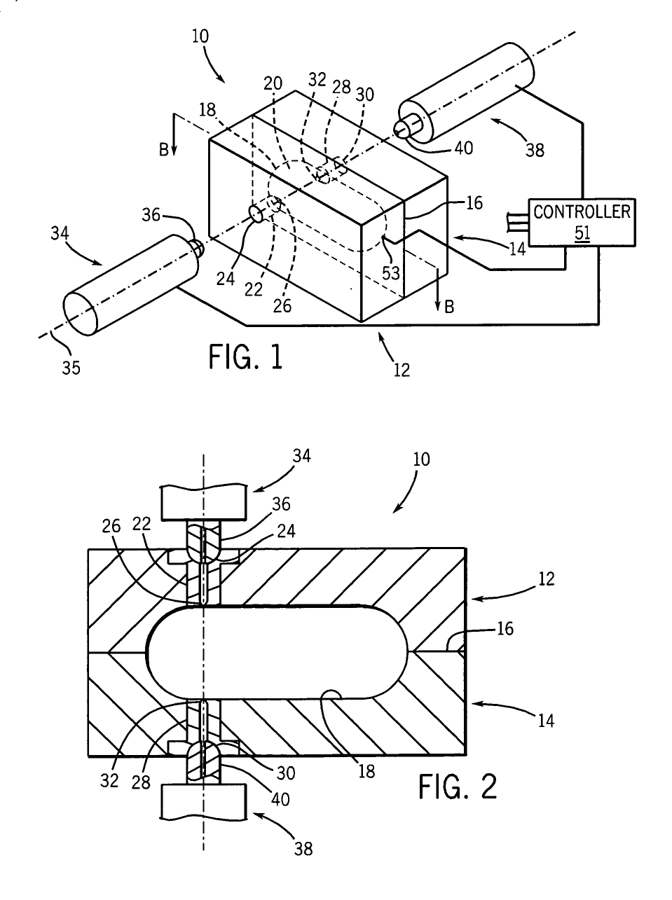

Referring now to FIG. 1, a mold 10 suitable for practice of the present invention may include of a front mold portion 12 and a rear mold portion 14 joined along a parting line 16 to define a mold cavity 18. After the sandwich injection molding process, the mold 10 will contain a molded part 20 which may be removed by separating the mold portions 12 and 14 along a longitudinal axis 35.

The front mold portion 12 contains a first straight runner passage formed by a sprue bushing 22 extending along the longitudinal axis A. As used herein, the term “runner” shall be any feed channel providing a connection between the nozzle of the injector and the gate including sprues and runners. The term may also be used for the plastic piece formed in this channel as context will make evident.

The first sprue bushing 22 has an inlet 24 located on a front face of the outside surface of the first mold portion 12 and a gate 26 located on the inside surface of the mold cavity 18. The rear mold portion 14 contains a second straight sprue bushing 28 also extending along the longitudinal axis 35. The second sprue bushing 28 has an inlet 30 located on the rear face of the outside surface of the mold portion 14 and gate 32 located on the inside surface of the mold cavity 18 opposite to the first gate 26 across the parting line 16.

It will be appreciated that these straight sprue bushings 22 and 28 are both simple to machine and simple to fit with heated sprue bushings or similar systems if desired. The coaxial opposition of the sprue bushings 22 and 28 further aids in locating the injectors described below. Generally, however, the gates 26 and 32 need not be opposite each other and may be arbitrarily close together so long as independent sprue bushings 22 and 28 are preserved.

A first injector 34, extending along axis 35, has a first machine nozzle tip 36 which can be placed against the first inlet 24 of the first sprue bushing 22. A second injector 38, also extending along axis 35, has a second machine nozzle tip 40 which can be placed against the second inlet 30 of the second sprue bushing 28. Once placed against the first and second inlets 24 and 30, the first and second injection nozzle tips 36 and 40 may inject thermoplastic material through the sprue bushings 22 and 28 to fill the mold cavity 18. In this first embodiment, the sprue bushings 22 and 28, the inlets 24 and 30, the gates 26 and 32, the injectors 34 and 38, and the injection nozzle tips 36 and 40 all extend along the axis 35, but it is not required that any of these elements be coaxial.

Referring now to FIG. 2, during a first step of the sandwich molding process, the mold portions 12 and 14 close along the parting line 16 to provide the mold cavity 18, and the first machine nozzle tip 36 and the second machine nozzle tip 40 are placed against the first inlet 24 of the first sprue bushing 22 and the second inlet 30 of the second sprue bushing 28, respectively.

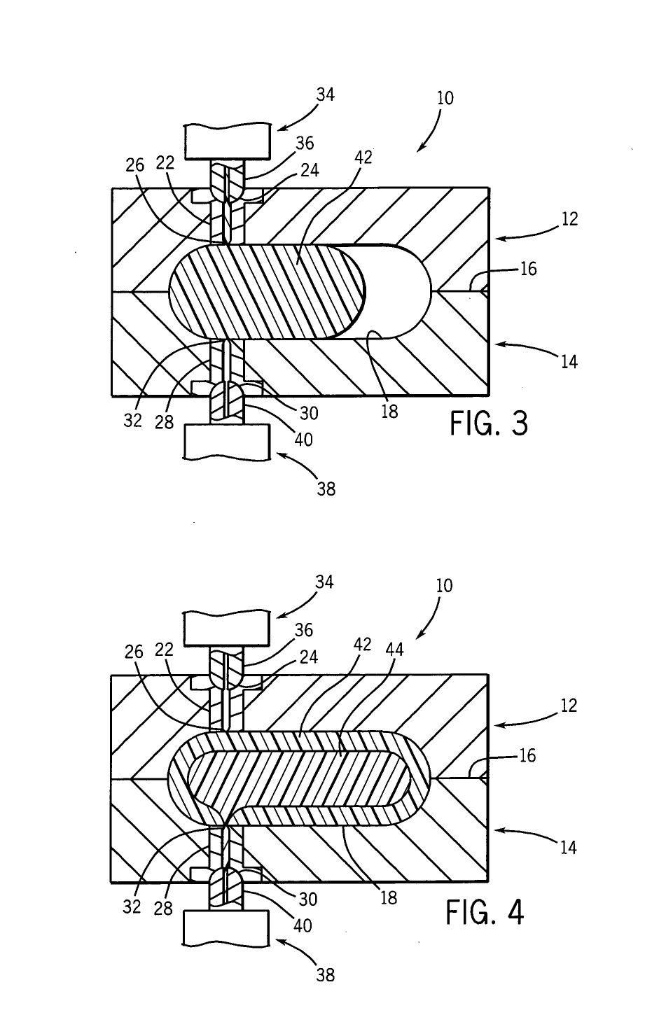

Referring now to FIG. 3, in a first embodiment, separation of the gates 26 and 32 is such that thermoplastic injected through one of the gates 26 or 32 covers the other gate 32 or 26 before the mold cavity 18 is filled, and preferably before the mold cavity 18 is filled by an amount over the ultimately desired ratio of core to skin material. Typically the thermoplastic material from the first gate will cover the second case before the mold cavity 18 is 30 percent and rarely more than 70 percent filled depending on the ratio of core to skin material desired in the final project.

During this step of the process, the first machine nozzle tip 36 injects the first thermoplastic material 42 into the mold cavity 18 via the first sprue bushing 22 and the first gate 26. The first machine nozzle tip 36 continues to inject the first thermoplastic material 42 into the mold cavity 18 until the first thermoplastic material 42 at least covers the second gate 32 of the second sprue bushing 28.

Referring now to FIG. 4, during the next step of the process, while the first thermoplastic material 42 is still molten, the second machine nozzle tip 40 injects the second thermoplastic material 44 into the mold cavity 18 via the second sprue bushing 28 through the second inlet 30. The first thermoplastic material 42 covers the second gate 32 of the second sprue bushing 28, so that when the second injection nozzles 40 injects the second thermoplastic material 44, the second thermoplastic material 44 flows inside the first thermoplastic material 42 with the first thermoplastic material 42 forming a skin about a core formed of the second thermoplastic material 44.

The skin may be selected to have desirable traits such as, for example, surface finish, color, hardness, wear resistance, high strength, or resistance to UV radiation. The core may be engineered or selected to have desirable traits such as low density, low cost, or high strength. The first thermoplastic material 42 will substantially wholly envelop the second thermoplastic material 44 as it is injected, so it is not necessary that the first and second thermoplastic materials 42 and 44 to bond. Often the fact the first thermoplastic material 42 encapsulates the second thermoplastic material 44 is sufficient to maintain structural integrity as the molded part 20 cools. The selection of materials with compatible cooling rates, temperatures of solidification, and volumetric changes upon solidification ensures that the molded part 20 forms properly for the particular size of the molded part 20 and the material properties of the first and second thermoplastic materials 42 and 44.

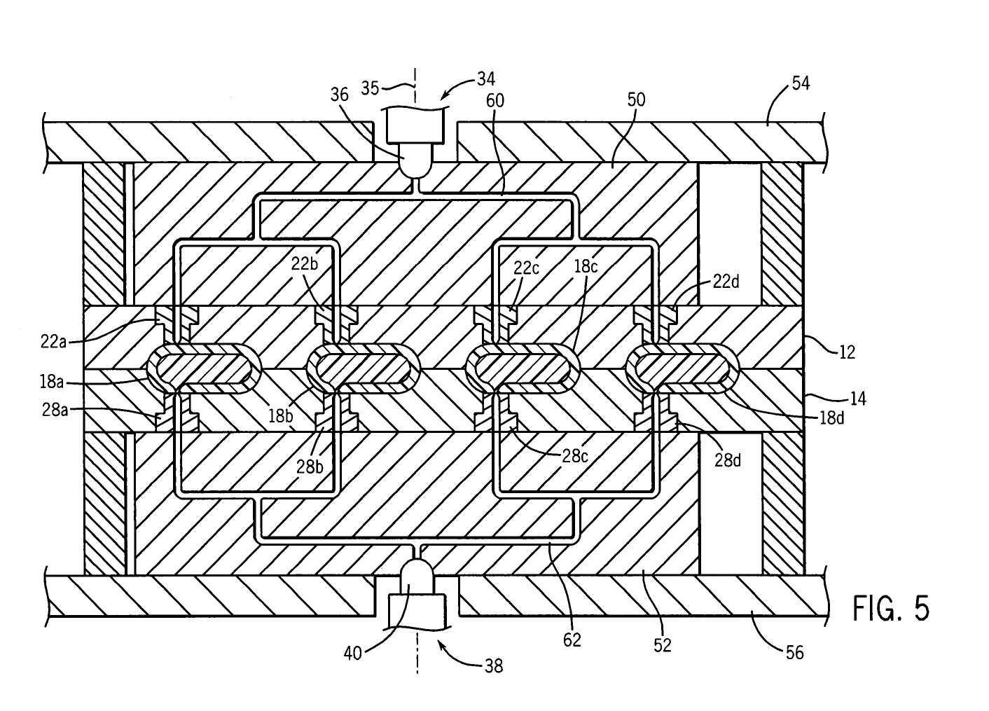

Referring now to FIG. 5, in a second embodiment of the invention, the mold portions 12 and 14 join along a parting line 16 to provide a plurality of mold cavities 18a, 18b, 18c and 18d. Hot runner manifolds 50 and 52 are held to the opposed outer faces of the mold portions 12 and 14 by clamp plates 54 and 56, respectively. The hot runner manifolds receive the nozzles tips 36 and 40 and provide balanced runners 60 and 62 branching to each of eight sprue bushings 22a-22d (for balanced runner 60) and 30a-30d (for balanced runner 62). Balanced runners provide identical flow resistance from the inlet at nozzle tips 36 and 40 to each of the cavities 18a-18b to provide comparable flow of thermoplastic along each branch.

The balanced runners 60 and 62 add complexity to the mold, but are still far simpler than would be required of conventional runner passages used for sandwich molding in which a common channel must handle two different materials from two different injectors. The simplicity and symmetry possible in the sprue bushings 22 and 28 in the present invention makes it substantially easier to balance flow rates into the various mold cavities 18, necessary if consistent sandwich molding among the mold cavities is to be obtained. Again the simple sprue bushings 22 and 28 make use of standard or simpler hot runner and similar systems practical.

While the embodiments of the invention include only two mold portions 12 and 14, sprue bushings 22 and 28, and injectors 34 and 38, it will be understood from this description that the sandwich molding of the molded part 20 may employ more than two mold portions 12 and 14, sprue bushings 22 and 28, and injectors 34 and 38. Additionally, a single mold cavity 18 may have a constricting cross section or may be so large as to use more than two sprue bushings 22 and 28 or injectors 34 and 38 to adequately fill the entire mold cavity 18. Such a demand is also compatible with the present invention.

Additionally, any given one of the mold portions 12 and 14 may include more than one of the sprue bushings 22 and 28 or none at all. That is, the first mold portion 12 or the second mold portion 14 may house both the first and the second sprue bushings 22 and 28. Conversely, one or more of the sprue bushings 22 and 28 may travel through one or more of the mold portions 12 and 14 or along the parting line 16.

When the sprue bushings 22 and 28 are on opposite mold portions 12 and 14, one injector may be advantageously mounted on the moving platen per U.S. application 2002/0102320, filed Aug. 1, 2002, entitled: “Multi-Shot Injection Molding Arrangement”, assigned to the present assignee, and hereby incorporated by reference.

As mentioned, the mold 10 as depicted in either the first or second embodiment may include a heated runner passage system. A hot runner passage, an insulated hot runner passage, or a hot manifold may keep the thermoplastic materials 42 and 44 fluid while in the sprue bushings 22 and 28. Such a mold modification can reduce gating scrap and improve material flow, especially in cases where the sprue bushings 22 and 28 are long.

Referring now again to FIG. 1, a standard controller 51 of a type known in the art may control the entire injection process including the opening and closing of the mold portions 12 and 14, the injection of the thermoplastic materials 42 and 44 into the sprue bushings 22 and 28 by the injectors 34 and 38, and the ejection of the part from the mold cavity 18. The controller 51 may coordinate the timing and volumes of the injection of the thermoplastic materials 42 and 44 by the injectors 34 and 38 by a simple timing mechanism or may include a feedback or triggering system that includes sensors 53 on the injectors 34 and 38 or at an in-mold location to determine when the first machine nozzle tip 36 has injected a sufficient amount of the first thermoplastic material 42 into the mold cavity 18.

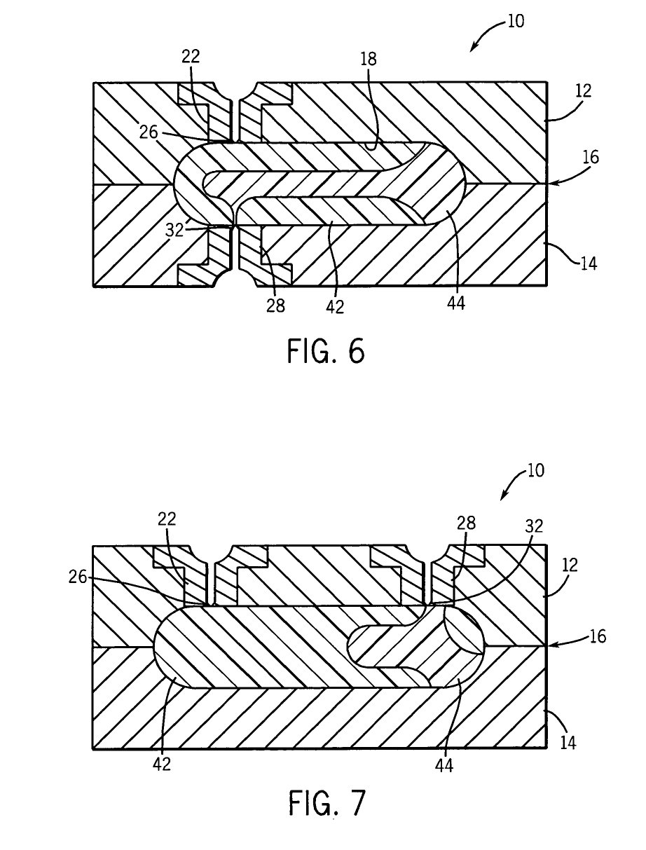

Referring now to FIG. 6, in an alternative embodiment of the invention, the gates 26 and 32 may be positioned with respect to the mold cavity 18, and the shot sizes may be controlled so that the inner thermoplastic material 44 is exposed through the outer thermoplastic material 42 while still being mechanically linked together. As shown in FIG. 7, when the inner thermoplastic material 44 is to be exposed, greater separation of the gates 26 and 32 can reduce the enveloping of the inner material 44 by the outer thermoplastic material 42 when it is desired to segregate the materials along an axis and/or allow for some degree of simultaneous injection.

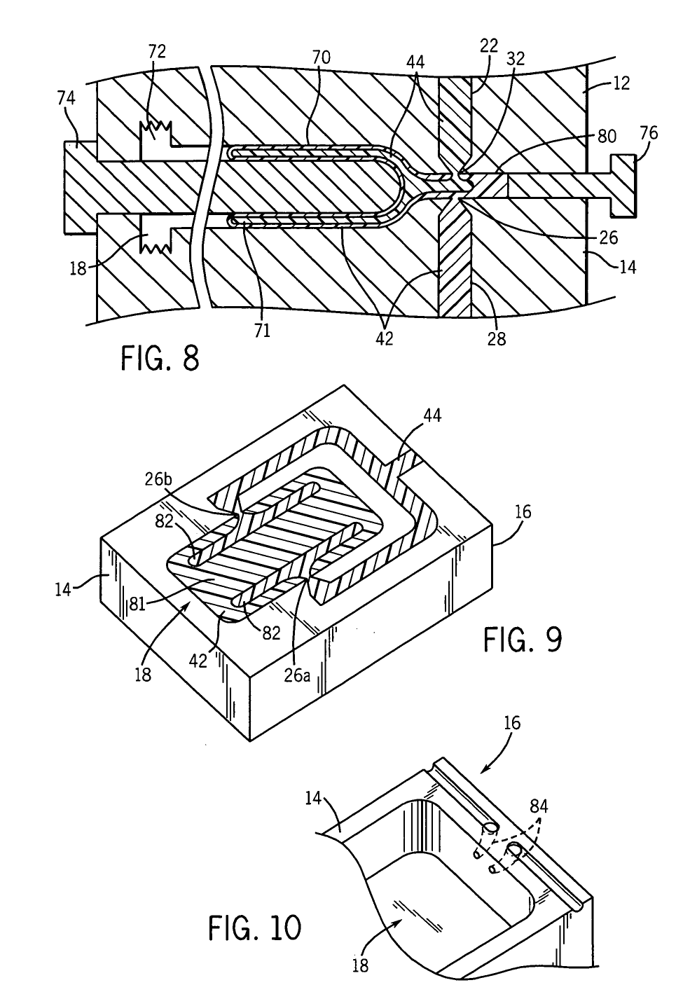

Referring now to FIG. 8, an important application of the present invention may be in molding preforms 70 used in a blow molding procedure. Such preforms 70 provide a generally test-tube shaped molded element with threads at the open end 72. The present invention provides a simple mold structure to be used in producing preforms 70 with different inner thermoplastic material 44 and outer thermoplastic material 42, the two materials providing, for example, a structural material and a gas blocking material.

In the mold, sprue bushings 22 and 28 or other runner systems are positioned across a temporary mold cavity 80 joined to the bottom of the preform cavity 71. A core pin 74 provides for the inner surface of the perform cavity 71, the outer surfaces provided by mold portions 12 and 14. Inner thermoplastic material 44 and outer thermoplastic material 42 are injected through opposed gates of the sprue bushings 22 and 28 into the temporary mold cavity 80 and the preform cavity 71 with the inner thermoplastic material 44 enveloped by the outer thermoplastic material 42.

A pin 76, as is understood in the art, is then moved inward (per FIG. 6) after completion of the injections of materials 42 and 44 to force the sandwich molded material completely into the preform cavity 17 eliminating a sprue attached to the perform 70.

Referring now to FIG. 9, the present invention provides for the ability to create a molded part 81 (shown in cross section) having multiple separate inclusions 82 formed of inner thermoplastic material 44 injected through different gates 26b and 26a. In the molded part 81, thermoplastic material 42 is introduced through a runner (not shown) in the bottom of the mold portion 14, and the inclusions 82 then formed within the molded part 81 at the gates 26b and 26a, for example, to provide for local reinforcement of the molded part 81.

Referring to FIG. 10, the present invention is not limited to runners which pass along the parting line 16 or perpendicular thereto, but may allow for the production hook gates 84 used to provide separate injection of materials 44 and 42.

Generally, it will be understood to those of ordinary skill in the art from the above description that the invention is not limited to thermoplastic materials but may be used with other commonly injected materials.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of sandwich molding comprising the steps of:
(a) joining a first mold portion and a second mold portion at a part line to define a mold cavity including a first runner passage and a second runner passage, the first runner passage having a first inlet leading to a first gate at a first location within the mold cavity, and the second runner passage having a second inlet leading to a second gate at a second location within the mold cavity;
(b) injecting a first injectable material through the first runner passage injectable material into the mold cavity without filling the mold cavity; and
(c) while the first injectable material is still molten, injecting a second injectable material through the second runner passage to join the first injectable material and fill the mold cavity.

2. The method of claim 1 wherein the first injectable material is injected into the mold cavity until the first injectable material covers the second gate.

3. The method of claim 2 wherein the first injectable material covers the second gate of the second runner passage when the first injectable material fills less than 33 percent of the mold cavity's volume.

4. The method of claim 2 wherein the first injectable material covers the second gate of the second runner passage when the first injectable material fills less than 70 percent of the mold cavity's volume.

5. The method of claim 1 wherein the first injectable material wholly envelops the second injectable material.

6. The method of claim 1 wherein the mold portions contain local heating elements to maintain a temperature of an injectable material by a heating means selected from the group of: a hot runner passage, an insulated hot runner passage, and a hot manifold.

7. The method of claim 1 wherein at least one of the first and second runner passages are balanced branches of runners extending to a plurality of identical mold cavities.

8. The method of claim 1 wherein a control system executes a program to perform steps (a) through (c).

9. A mold for sandwich molding a multi-layer thermoplastic part having an inner thermoplastic layer and an outer thermoplastic layer, said mold comprising:
a first mold portion and a second mold portion, the first mold portion and second mold portion capable of joining along a part line to provide a mold cavity;
a first runner passage and a second runner passage, the first runner passage having a first inlet leading to a first gate at a first location within the mold cavity, and the second runner passage having a second inlet leading to a second gate at a second location within the mold cavity; and
whereby sequential injections of a first injectable material into the first runner passage and a different second injectable material into the second runner passage may be made into the mold cavity, the first injectable material first covering the second gate of the second runner passage and the second injectable material filling within the first injectable material as the second injectable material then is injected into the mold cavity so that the second injectable material is substantially enveloped by the first injectable material.

10. The mold of claim 9 wherein the mold contains local heating elements to maintain a temperature of an injectable material by a thermo-controlling means selected from the group of: a hot runner passage, an insulated hot runner passage, and a hot manifold.

11. The mold of claim 9 wherein at least one of the first and second runner passages branch to extend through at least one of the mold portions to a plurality of mold cavities.

12. The mold of claim 9 wherein the first and second runner passages only extend through the first mold portion.

13. The mold of claim 9 wherein the first runner passage extends through the first mold portion, and the second runner passage extends through the second mold portion.

14. The mold of claim 9 wherein the mold includes one mold cavity.

15. An apparatus for sandwich molding of a multi-layer thermoplastic part having an inner thermoplastic layer and an outer thermoplastic layer, said apparatus comprising:
a first mold portion and a second mold portion, the mold portions capable of joining along a part line to provide multiple mold cavities;
first runner passages having a first inlet leading to a first gate at a first location within each mold cavity;
second runner passages having a second inlet leading to a second gate at a second location within each mold cavity;
a first manifold providing balanced runners leading from an injection point to each of the first runner passages;
a second manifold providing balanced runners separate from the balanced runners of the first manifold leading from an injection point to each of the second runner passages;
a controller operating a first and second injector to:
(i) inject a first injectable material through the first manifold into the mold cavities without filling the mold cavities; and
(ii) while the first injectable material is still molten, injecting a second injectable material through the second manifold to join the first injectable material and fill the mold cavities.

16. The apparatus of claim 15 wherein the first injectable material is injected into the mold cavities until the first injectable material covers the second gates in each mold cavity.

17. The apparatus of claim 16 wherein the first injectable material covers the second gates of the second runner passages when the first injectable material fills less than 33 percent of the mold cavity's volume.

18. The apparatus of claim 16 wherein the first injectable material covers the second gates of the second runner passages when the first injectable material fills less than 70 percent of the mold cavity's volume.

19. The apparatus of claim 15 wherein the first injectable material wholly envelops the second injectable material.

20. The apparatus of claim 15 wherein the controller is a timer.

21. The apparatus of claim 15 wherein the control mechanism includes a sensor that detects when a proper amount of the first injectable material has been injected into the mold cavity.
